(19) United States
(12) Patent Application Publication
(10) Pub. No.: US 2013/0312542 A1
(43) Pub. Date: Nov. 28, 2013

(54) Liquid Natural Gas Conditioning Cabinet With Overpressure Relief Drain/Vent

(71) Applicant: Mustang Sampling LLC, Ravenswood, WV (US)

(72) Inventor: Claude A. Rolston, St. Marys, WV (US)

(73) Assignee: Mustang Sampling LLC, Ravenswood, WV (US)

(21) Appl. No.: 13/901,908

(22) Filed: May 24, 2013

Related U.S. Application Data
(60) Provisional application No. 61/651,874, filed on May 25, 2012.

(51) Int. Cl. G01D 11/24

(52) U.S. Cl. CPC G01D 11/24
USPC 73/863.12; 73/431

(57) ABSTRACT

A liquid natural gas sample conditioning cabinet structure with a covered vent disposed proximate to the cabinet floor for preventing pooling of and venting heavier-than-air hydrocarbon gases.

### FIELD OF INVENTION

The present invention is directed to mitigating problems caused by heavier-than-air hydrocarbon accretion/pooling in a heated sample conditioning cabinet. More particularly, the invention herein contemplates the relatively simple expedient of incorporating a vent proximate to a cabinet interior floor to relieve pressure accumulation of heavier-than-air flammable/explosive gaseous components while preventing ingress to the cabinet interior by environmental elements and pests.

### BACKGROUND

Conventional flammable/explosive gas conditioning cabinet structures are constructed to isolate the interior components from ambient environmental conditions and to provide a heated environment for the contents to minimize the adverse impact from liquid condensation resulting from Joule-Thompson cooling. Accordingly, it is preferred that the interior of a sample conditioning cabinet be maintained at a temperature of about 100° F. to 120° F. Examples of such cabinets can be found described in U.S. Pat. Nos. 7,484,404 and 8,056,399, the subject matter of each being incorporated herein by reference. In the natural gas industry, such cabinets need to conform to recognized standards for safety and performance such as the 4X standard of the National Electrical Manufacturing Association (“NEMA”) and its international equivalents.

Although it is not desired and is not a common occurrence, occasionally leakage of LNG into the cabinet from a valve failure or the like may occur. In such an event, the then unpressurized cryogenic, liquid quickly vaporizes and expands in excess of 600 fold by volume. As such, a small amount of leaked liquid LNG can generate significant pressure in the cabinet interior upon gasification. Furthermore, a large proportion of the LNG is composed of methane (CH₄), it also contains a proportion of larger hydrocarbons including ethane (C₂H₆), propane (C₃H₈), and even butane isomers (C₄H₁₀). All of these larger hydrocarbons possess densities that are heavier than air. Consequently, when a liquid LNG leak occurs within a sample conditioning cabinet those “heavy” hydrocarbons, being heavier than air, tend to settle or pool at the floor/the bottom of cabinet interior.

In the natural gas transmission and transportation industries, conditioning cabinet units are typically located in environmentally hostile ambient locations remotely located from a primary facility, and accessed only periodically. In addition to providing effective temperature maintenance of the interior components, a cabinet must also provide sufficient shelter against adverse environmental factors, i.e., inclement weather, water penetration, and ingress of pests (rodents, reptiles, and insects). Furthermore, some prior art constructions allow for the escape of the lighter-than-air methane LNG component from the cabinet interior by incorporating a the venting port located near the top of the cabinet. Other prior art constructions incorporates a capped, probe insertion port in the upper portion of the cabinet. A gas measuring probe may be inserted into the cabinet interior through the uncapped port for detection of accumulated methane in the cabinet. These present constructions and techniques do not recognize or contemplate venting structures that address the problem created by accretion/pooling of hazardous, vaporized heavier hydrocarbons at the cabinet interior while providing appropriate isolation from external environmental elements and pest ingress.

### SUMMARY OF INVENTION

It is an object of the present invention to address the foregoing problems in the prior art constructions.

It is another object to mitigate the heavier-than-air hydrocarbon pooling problem in a sample conditioning cabinet.

Still another object of the invention is to provide for venting of pressurized and pooled vaporized heavier-than-air hydrocarbons from a conditioning cabinet interior while providing against ingress from exteriorly originating factors such as water or pests.

Another object of the invention is to It has been determined that inclusion of a relatively small covered aperture may be incorporated near the floor and into the side wall of an otherwise sealed cabinet to provide sufficient venting/relief for interior over-pressurization brought on by evaporation of a liquid into its highly flammable gaseous form.

Another object of the invention is to reduce the danger associated with concentration of gaseous heavy hydrocarbons in a sample conditioning cabinet.

Another object of the invention is to provide a cabinet venting structure that includes foreign object (insect and plant life form) ingress protection.

These and other objects are satisfied by a liquid natural gas sample conditioning cabinet, comprising: an enclosure with a floor, a ceiling, and a plurality of walls defining an environmentally isolated interior space; a port for input of liquid natural gas to the enclosure interior space disposed in a wall between the floor and the ceiling; a heat source for maintaining the interior space within a select temperature range; gas sample conditioning vaporizing components and transport tubing for liquid and vaporized gas within the interior space; a venting feedthrough aperture formed in a select wall proximate to the floor; and a louvered cover over said aperture to permit egress of gasses through the aperture from the interior while preventing ingress of exteriorly originating objects through the aperture.

Other objects are satisfied by a method of avoiding accumulation of heavier than air hydrocarbon gas components from liquid natural gas processing in a sample cabinet interior proximate to the cabinet floor, comprising the steps of: introducing liquid natural gas into the cabinet interior through an input port, conditioning and vaporizing a sample of the liquid natural gas; providing a covered aperture proximate to the cabinet floor; and venting pooled, vaporized heavier-than-air liquid natural gas to the cabinet exterior.

Based on Applicant's experiences, it has been determined that inclusion of a vented aperture incorporated proximate to the floor and into the side wall of an LNG sample conditioning cabinet provides relief from over-pressurization resulting from pooling of gaseous heavier-than-air hydrocarbons resulting from leakage or evaporation/gasification and expansion of LNG within the cabinet interior.

Because sample cabinet units are typically located in an exterior, ambient environment, it is also prudent to address and prevent the unwanted intrusion of pests into the cabinet interior. For this reason, the invention contemplates an over-pressurization venting aperture that is preferably covered by a metal, louvered type drain cover. Alternatively, the invention contemplates provision of exterior venting coupled with prevention of undesirable ingress of exterior elements/pests by employing a covering adjunct with the vented aperture such as a foraminous mesh or screen or another other sturdy, rugged, perforated barrier structure that may be formed from a rugged material, e.g., metal, ceramic, etc. preventing ingress of ambient elements and pests while permitting egress of pooled hydrocarbon gas.

Venting near a cabinet base is contrary to considerations of infestation. The invention also prevents the unwanted intrusion of pests into the cabinet interior. For this reason, the over-pressurization venting aperture is preferably covered by a metal, louvered type drain cover that may or may not be combined with a screen or other rugged, perforated structure composed of a relatively rigid material, e.g., metal, ceramic, etc. that permits egress of pooled gas but preventing ingress of undesirable elements originating in the ambient environment of the cabinet.

The invention is not complicated but is important. In the simplest form, it essentially comprises a covered aperture located near a cabinet floor.

For definitional purposes and as used herein “connected” includes physical, whether direct or indirect, permanently affixed or removably mounted, as for example, a louvered cover is connected to the cabinet opening. Thus, unless specified, “connected” is intended to embrace any operationally functional connection.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, and which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 is a first side view schematic drawing of a LNG cabinet according to the invention.

FIG. 2 is a side view of a cabinet exterior of an LNG cabinet of FIG. 1.

FIG. 3 is front schematic view of an alternative embodiment of the LNG cabinet according to the invention.

FIG. 4 is a photographic image of a louvered vent cover according to an embodiment of the invention.

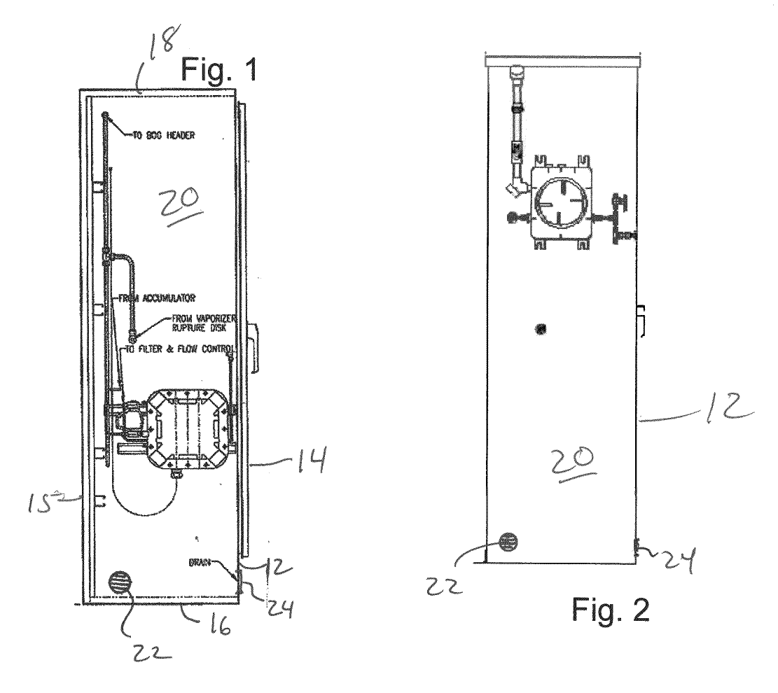

### DETAILED DESCRIPTION

FIG. 1 schematically illustrates a portion of the interior sample conditioning and storage cabinet 12 with front access panel/door 14. The floor 16, ceiling 18 and rear wall 15 are typically constructed from stainless steel or a laminated GRP (glass Reinforced Polyester) material. In the case of GRP, the insulation is disposed between the discrete laminated layers. The side wall 20 of the cabinet 12 of FIG. 1 includes a drain/vent port 22 for venting the interior of the cabinet to the outside. The drain/vent port 22 prevents over pressurization in case of leak of a LNG in the cabinet interior which itself is typically heated and maintained a temperature of between 100 F to 120 F. Consequently, when a liquid leak occurs, the liquid vaporizes and heavier-than-air components pool at the bottom of the cabinet interior floor 16 and can accrue to an extent that a positive pressure build-up results.

The presence of the drain/vent 22 prevents over pressurization in case of a LNG leak. The drain/vent 22 is covered with a louvered member 28 of the type illustrated in FIG. 4, to provide the necessary venting while allowing the interior of the cabinet to maintained a temperature of between 100 F to 120 F and preventing ingress of foreign materials (water, pests, etc. to the cabinet interior. Although not necessary, the cabinet 12 may include a second vent port 24 incorporated in the front wall below the access panel 14 and above the floor 16 to provide a redundant escape gas exhaust conduit. Because the same principals and concerns apply, that vent port is also covered with a louvered cover which may or may not include a screen mesh integrated on its interior facing side of the type described in U.S. Pat. No. 4,592,271, the content of which is incorporated by reference herein.

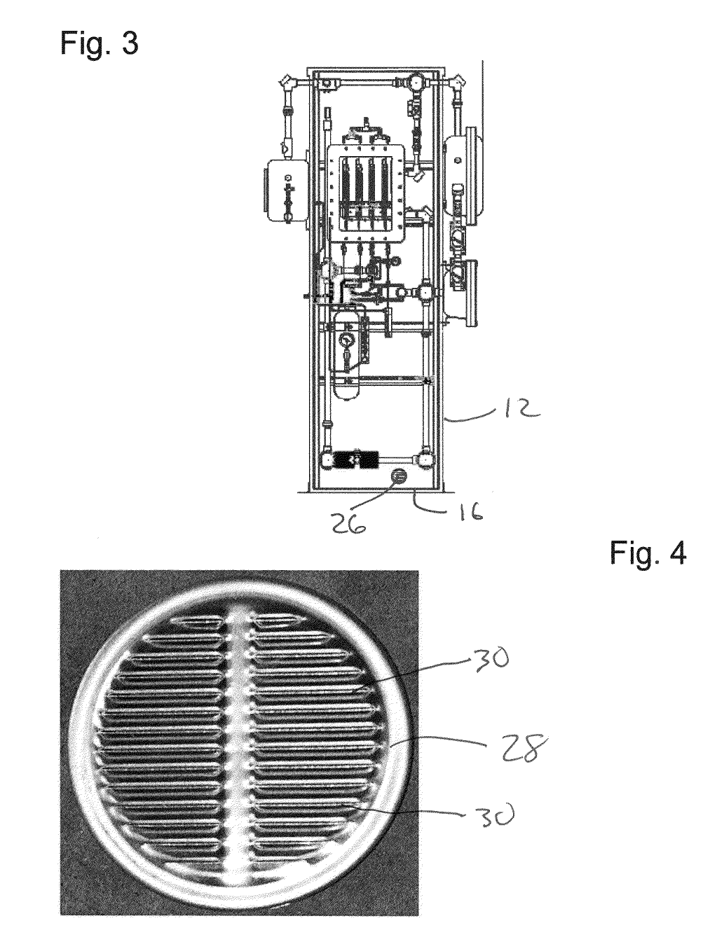

FIG. 3 illustrates another embodiment that satisfies the functionality of the invention as described above, namely, the relief from overpressure build up from heavier-than-air hydrocarbon gas pooling in a sample cabinet. In FIG. 3 the vent 26 is incorporated into the rear wall of the cabinet.

FIG. 4 is a depiction of a louvered vent cover 28 that is stamped from aluminum incorporates very narrow slits 30 providing for gas egress and ingress but preventing ingress of liquid or pests. A vent cover meeting this criteria is available as a 1½ inch round RLS series unit from Midget Louver of Milford, Conn.

Although only select embodiments of the invention have been disclosed in the forgoing specification, it is understood by those skilled in the art that many modifications and embodiments of the invention will come to mind to which the invention pertains, having benefit of the teaching presented in the foregoing description and associated drawing. It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

I claim:

1. A liquid natural gas sample conditioning cabinet, comprising: an enclosure with a floor, a ceiling, and a plurality of walls defining an environmentally isolated interior space; a port for input of liquid natural gas to the enclosure interior space disposed in a wall between the floor and the ceiling; a heat source for maintaining the interior space within a select temperature range; gas sample conditioning vaporizing components and transport tubing for liquid and vaporized gas within the interior space; a venting feedthrough aperture formed in a select wall proximate to the floor; and a louvered cover over said aperture to permit egress of gasses through the aperture from the interior while preventing ingress of exteriorly originating objects through the aperture.

2. The liquid natural gas sample conditioning cabinet of claim 1 where the walls are formed from a material selected from the group consisting of stainless steel and glass re-enforced polyester.

3. The liquid natural gas sample conditioning cabinet of claim 2 where the aperture has a diameter of one and a half inches (˜3 cm).

4. The liquid natural gas sample conditioning cabinet of claim 3 where the louvered cover is formed from a material selected from the group consisting of stamped aluminum sheeting and machined stainless steel.

5. The liquid natural gas sample conditioning cabinet of claim 3 where the louvered cover includes a mesh screen to prevent ingress of pests to the cabinet interior.

6. In combination: a cabinet forming an environmentally isolated enclosed interior with a roof, an access panel, a floor, and at least a pair of side walls; an input port for introduction of a cryogenic fluid stream to the enclosed interior, a vaporizing means for converting the cryogenic fluid stream into vaporized gas; an output port for transporting vaporized gas from the enclosed interior; tubes for communicating and a covered vent disposed in at least one of the a side walls proximate to the floor of the cabinet for venting escaped heavier-than-air gases from said enclosed interior.

7. The combination of claim 6 where the vent is covered by a stamped, louvered aluminum member.

8. The combination of claim 6 where the louvered aluminum member cover includes a mesh screen to prevent ingress of pests to the cabinet interior

9. A method of avoiding accumulation of heavier than air hydrocarbon gas components from liquid natural gas processing in a sample cabinet interior proximate to the cabinet floor, comprising the steps of:
introducing liquid natural gas into the cabinet interior through an input port,
conditioning and vaporizing a sample of the liquid natural gas;
providing a covered aperture proximate to the cabinet floor; and
venting pooled, vaporized heavier-than-air liquid natural gas to the cabinet exterior.
